(19) United States
(12) Patent Application Publication
(10) Pub. No.: US 2008/0102199 A1
(43) Pub. Date: May 1, 2008

(54) Multi-wafer rotating disc reactor with wafer planetary motion induced by vibration

(75) Inventor: Alex Gurary, Bridgewater, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Veeco Instruments Inc., Woodbury, NY (US)

(21) Appl. No.: 11/588,440

(22) Filed: Oct. 26, 2006

(51) Int. Cl. B05C 13/02; B05D 3/12

(52) U.S. Cl. 427/240; 118/52

(57) ABSTRACT

A system and method for uniform deposition of material layers on wafers in a rotating disk chemical vapor deposition reaction system is provided, wherein a plurality of wafers are rotated on a susceptor at a first rate around a first axis by a first motor, and the plurality of wafers rotate independently exhibiting planetary motion at a second rate through application of a vibrational force from a vibration source in a direction transverse to the first axis of rotation.

### BACKGROUND OF THE INVENTION

In chemical vapor deposition systems, uniform deposition on wafer surfaces is of prime importance. In a typical chemical vapor deposition system, one or more wafers is placed in a wafer carrier, and the carrier is placed in a reaction chamber for deposition. The wafer carrier may be heated by, for example, placing it on a susceptor, and reaction gases are provided into the reaction chamber via gas inlets, gas showerheads, and the like to initiate the growth of material layers on the wafers.

In order to improve uniformity of deposition, numerous methods have been employed. For example, various modified gas showerheads, rotating susceptors and wafer carriers, modified wafer carrier shapes, and different reaction chamber shapes, have been proposed or used in order to increase deposition uniformity. While each of these methods has met with varying degrees of success, additional improvement in the uniformity of deposition layer growth on the surface of each wafer is desired.

Chemical vapor deposition systems in which the wafer carrier is rotated tend to increase deposition uniformity. In systems with wafer carriers holding multiple wafers, some systems have been modified to attempt to rotate the wafer carrier on which the wafers are seated at a first rate, while rotating the wafers around themselves (within their wafer seat) at a second rate, thus creating planetary motion of the wafers in the wafer carrier. Such systems have been suggested using planetary gear systems, motor drivers rotating the wafer carrier and the wafers placed thereon, unusual wafer carrier configurations which cause wafer movement therein, or application of gases to the wafers held in the wafer carrier via gas channels in the wafer carrier in order to induce wafer movement.

Each of these systems has drawbacks, however. Complex gear and motor systems in the wafer carrier itself may be difficult to maintain because the wafer carrier is subjected to reactant gases, heat, and rotational forces. Thus cleaning the wafer carrier is made more complex, and the usable lifetime of the mechanics of the system may be negatively impacted.

Similarly, gas channels in the wafer carrier to induce wafer movement, and unusual wafer carrier shapes to induce wafer carrier movement, require additional cleaning and care due to their complexity. More importantly, extra application of gas to the wafer from the wafer carrier, or unusual wafer carrier shapes, might adversely affect the integrity of the wafer structure without substantially improving uniformity of deposition.

Thus, what is needed is a system to improve deposition without the maintenance, complexity and performance drawbacks of present systems.

### SUMMARY OF THE INVENTION

In one embodiment, a wafer treatment system is disclosed, comprising: a reaction chamber, a wafer carrier mounted within the chamber for rotation therein about an axis, the wafer carrier adapted to carry a plurality of wafers, a drive for rotating the wafer carrier around the axis, a vibration source vibrationally coupled to the wafer carrier for transferring an oscillatory force to the carrier substantially transverse to the axis, such that the plurality of wafers placed in the carrier exhibit planetary motion.

In one embodiment, a method for treating wafers is disclosed, comprising: rotating a wafer carrier at a first rotational rate around an axis, applying an oscillatory force substantially transverse to the axis to the wafer carrier so that a plurality of wafers placed in the wafer carrier exhibit planetary motion, and treating the plurality of wafers.

### BRIEF DESCRIPTION OF THE DRAWINGS

FIG. 1 provides a side representation of one embodiment of a wafer treatment system of the present invention.

FIG. 2 provides an overhead representation of one embodiment of a wafer carrier for use with the present invention.

FIG. 3 provides a cross-sectional representation of one embodiment of a wafer compartment of a wafer carrier for use with the present invention.

FIG. 4 provides a cross-sectional representation of one embodiment of a wafer compartment of a wafer carrier for use with the present invention.

FIG. 5 provides a side representation of one embodiment of a wafer treatment system of the present invention.

FIG. 6 provides a cross-sectional representation of one embodiment of a wafer treatment system of the present invention.

### DETAILED DESCRIPTION

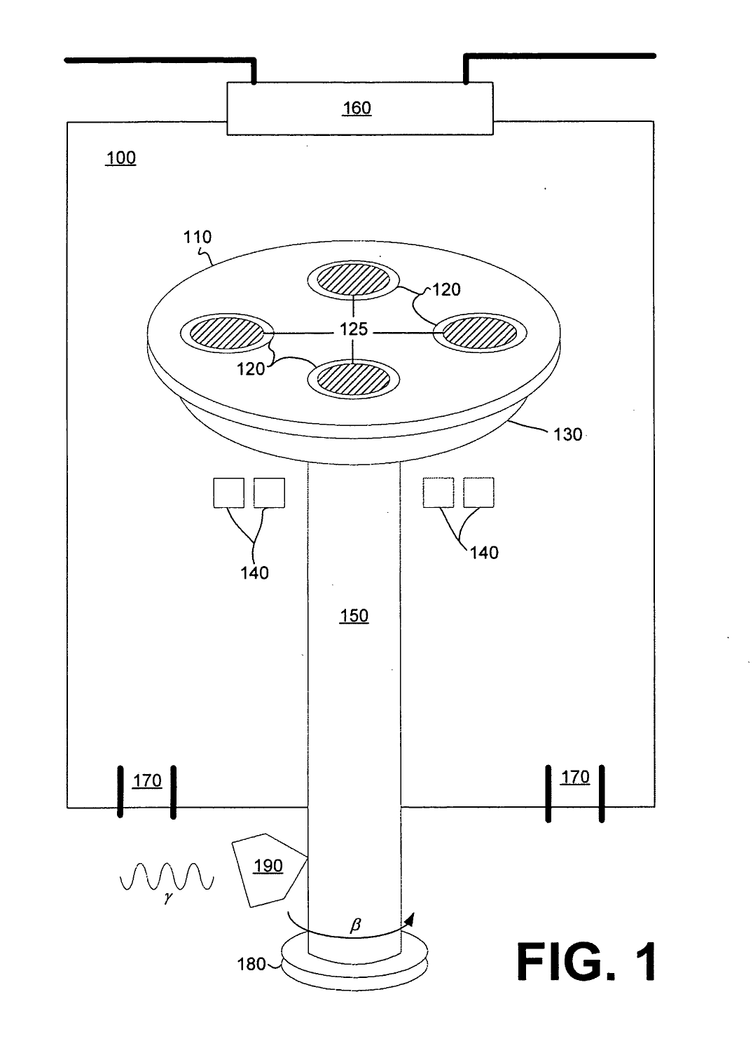

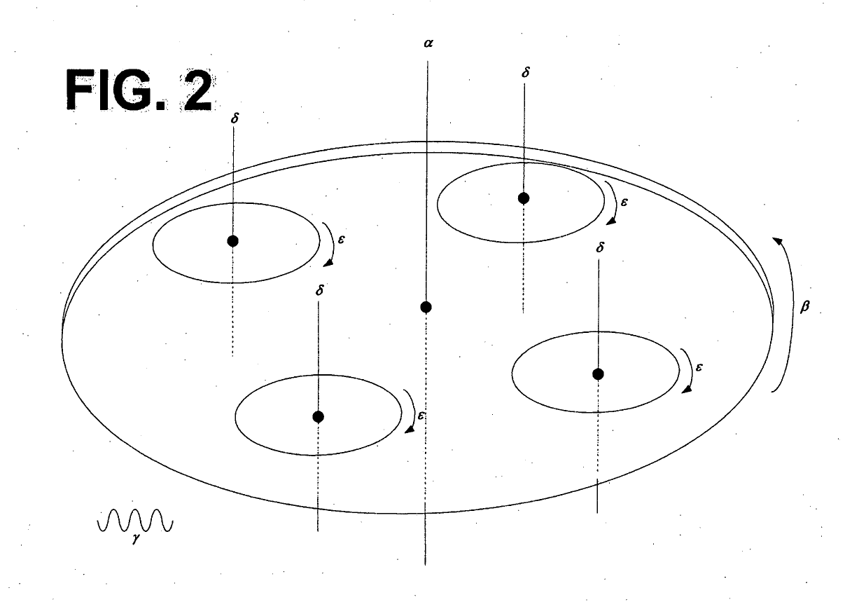

FIG. 1 provides a side representation of one embodiment of a wafer treatment system of the present invention. A reaction chamber 100 includes a wafer carrier 110 placed therein. The wafer carrier 110 includes a plurality of wafer compartments 120 in which a plurality of wafers 125 are placed. The wafer carrier 110 is seated on a susceptor 130, which transmits heat to the wafer carrier 110 from heating elements 140. The susceptor 130 and wafer carrier 110 are seated on a spindle 150. Above the wafer carrier, a flange 160 provides one or more reaction gases 165 to the reaction chamber 100 for deposition processes to be performed on the wafers 125. Reaction gases leave the reaction chamber 100 via exhaust outlets 170. As shown in more detail in FIG. 2, which provides an overhead representation of one embodiment of a wafer carrier for use with the present invention, the first motor 180 provides primary rotation to the spindle 150 and wafer carrier 110 placed thereon. The vibration source 190 provides a transverse vibration force to the spindle 150 and wafer carrier 110, which is communicated to individual wafers 125, inducing planetary motion in the wafers 125.

In particular, the spindle 150 is rotated by a first motor 180 around a central axis of the spindle (α) at a first rate (β). The spindle 150 communicates the rotation to the susceptor 130 and wafer carrier 110.

A vibration source 190, preferably a piezoelectric motor, is also in physical contact with the spindle 150. The vibration source 190 communicates an oscillatory vibration (γ) substantially transverse to the central axis (α) of rotation of the spindle 150 and first motor 180. This transverse vibration (γ) is communicated through the spindle 150 and susceptor 130 to the wafer carrier 110. At the wafer carrier 110, the transverse vibration (γ) induces planetary motion of the plurality of wafers 125 held in the wafer compartments 120 of the wafer carrier 110. This planetary motion is typically exhibited as the rotation of each wafer around its own central axis (δ) at a second rate (ε) distinct from the first wafer carrier 110 central axis (α) and the wafer carrier 110 first rate of rotation (β).

Preferably, although it is not required, if the spindle 150 extends outside of the reaction chamber 100, then both the vibration source 190 and the first motor 180 are preferably located outside of the main reaction chamber 100 and communicate their respective rotational and vibrational energy to the wafer carrier 110 in the reaction chamber 100 through the spindle 150 which extends therethrough.

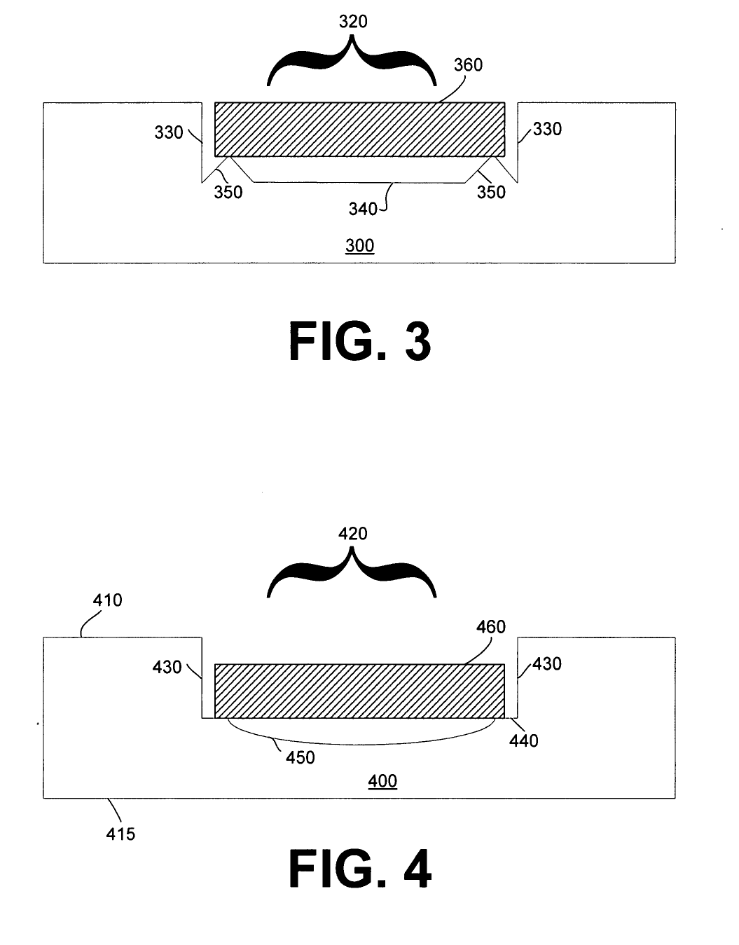

FIG. 3 provides a cross-sectional representation of one embodiment of a wafer compartment of a wafer carrier 300 for use with the present invention. One wafer carrier 310 for use with the present invention includes a plurality of wafer compartments 320 with sides 330 and a base 340. The base 340, in this embodiment, includes vertical dimples 350. When a wafer 360 is placed therein, the wafer 360 is seated on the vertical dimples 350.

FIG. 4 provides a cross-sectional representation of one embodiment of a wafer compartment of a wafer carrier 400 for use with the present invention, with at least a top surface 410 and a bottom surface 415. The top surface 410 of the wafer carrier 400 includes a plurality of wafer compartments 420 with sides 430 and a base 440. The base 440 includes a nonlinear surface 450, such that when a wafer 460 is placed therein, the wafer 450 is not in contact with the entirety of the base 440, and particularly is not in contact with at least part of the nonlinear surface 450.

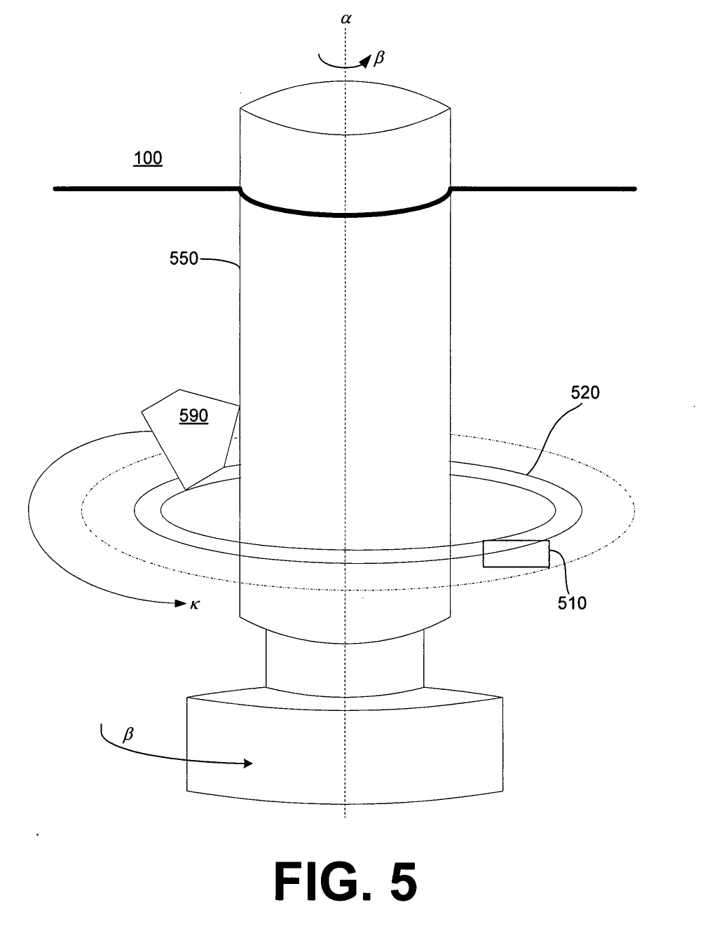

FIG. 5 provides a side representation of one embodiment of a wafer treatment system of the present invention, where the vibration source 190 itself rotates around said central axis (α) at a third rate (ζ) via a third motor 500. The vibration source 190 may be placed on a platform 510, a rotating arm, or another device or mechanism through which it rotates around the spindle 150.

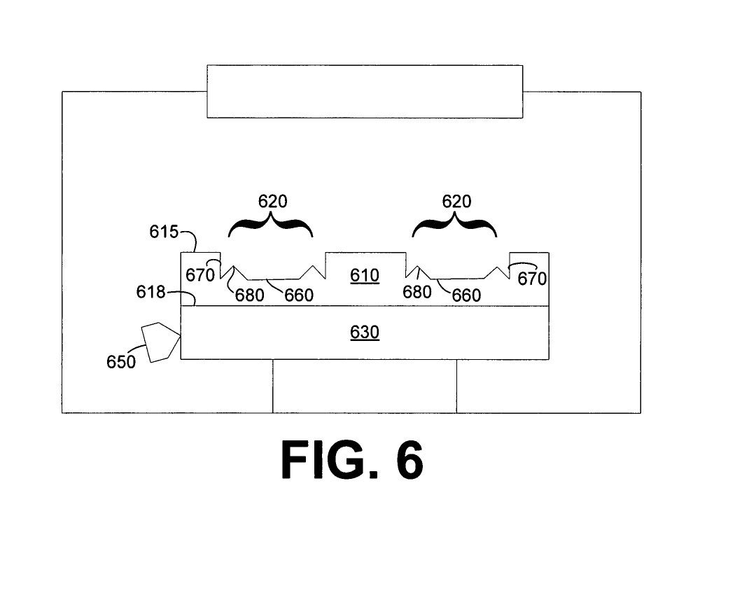

FIG. 6 provides a cross-sectional representation of one embodiment of a wafer treatment system of the present invention. A wafer carrier 600 with a top surface 610 and a bottom surface 615 includes a plurality of wafer compartments 620 in the top surface 610 of the wafer carrier 600. The bottom surface 615 of the wafer carrier 600 is seated on a platform 630. Each wafer compartments 620 in the wafer carrier 600 includes at least sides 640 and a base 650. Preferably, the base 650 of the wafer compartments 620 includes a nonlinear surface 660 on which a wafer (not shown) is seated when placed in the wafer compartments 620. A vibration source 670, preferably a piezoelectric motor, is placed in vibrational contact with the platform 630, thereby communicating vibrational energy from the source 670 through the platform 630 to the wafer carrier 600 and any wafers placed therein.

In one experimental test, vibrations were created using a magnetic bearing feedback system with a standard vacuum pump drive, two radial bearings separated by approximately six inches, an axial bearing and an integral rotary drive. Two frequency generators (Hewlett Packard) were employed to supply independent oscillations to drive the magnetic bearing feedback systems. For testing, 180 mm wafer carriers composed of graphite, molybdenum, and aluminum were employed. The graphite and molybdenum wafer carriers each had a single symmetric ring of six wafer compartments, where each compartment held a two inch diameter wafer. The aluminum carrier held a single two inch diameter wafer.

Frequency and amplitude were varied on each axis independently, and in combination, with the following results:

TABLE 1

| Carrier Type | Vert. Freq. | Horiz. Freq. | Wafer Rotation |
|---|---|---|---|
| Molybdenum (6) | 19 Hz | 728 Hz | ~0.3–0.5 Hz |
| Graphite (6) | 28 Hz | 783 Hz | ~0.3–0.5 Hz |
| Aluminum (1) | 230 Hz | 455 Hz | ~1 Hz |
| Aluminum (1) | 450 Hz | 446 Hz | ~1 Hz |

Vibration frequency was found to have more significant effect than amplitudes. While vibration amplitudes were tested from 50 microns to 200 microns, little change was observed over this range. In contrast, a change of ±1 Hz was found to significantly effect rotation, such that a change of ±2 Hz from the greatest amount of wafer rotation would stop wafer rotation. In experimental setups, secondary rotation of the wafer carrier itself was found to impede wafer rotation above a wafer carrier rotation speed of about 150 RPM for multiple wafer carriers such as the Molybdenum and Graphite wafer carriers tested. For single wafer carriers, independent wafer rotation continued through 1000 RPM, the highest sped tested. In testing, wafers with clean smooth bottom surfaces were found to rotate more freely than those with dirty or pitted bottom surfaces, but textures of the bottom surface of the wafer carrier itself did not appear to have a significant effect on rotation of the wafers. Finally, at very high amplitudes, the wafer carrier itself begins to demonstrate secondary rotation (akin to precession) independent of primary wafer carrier rotation.

Mixing of process gas at the wafer surface may be advantageously enhanced by enforcing planetary motion of the wafer through vibrational forces. Moreover, planetary motion of a wafer may be enforced by varying vibrational forces over time (rather than constant vibrational forces at the same frequency). In particular, a pattern of vibrations at set intervals, say, for example, a 50 RPM jerk (change in acceleration) in rotational speed at frequent intervals may cause a rotation that would result in advantageous planetary motion of wafers. Similarly, temporarily and briefly reducing wafer carrier rotation speed to below 150 RPM while applying vibrational forces to the wafer carrier may be sufficient for inducing sufficient planetary motion in wafers.

As shown in FIGS. 3 and 4, above, dimples in the edge of the wafer compartments may change the frictional relationship between the wafer and the wafer carrier to assist in bringing about wafer vibration and wafer carrier rotation rates above 150 RPM, and other pocket shapes for the wafer compartment may bring about a similar effect.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A wafer treatment system, comprising:
a reaction chamber,
a wafer carrier mounted within said chamber for rotation therein about an axis, said wafer carrier adapted to carry a plurality of wafers,
a drive for rotating said wafer carrier around said axis,
a vibration source vibrationally coupled to said wafer carrier for transferring an oscillatory force to said carrier substantially transverse to said axis, such that plurality of wafers placed in said carrier exhibit planetary motion.

2. The system of claim 1, wherein said vibration source is selected from the group consisting of a piezoelectric motor and a solenoid.

3. The system of claim 1, further comprising a spindle upon which said wafer carrier is mounted, wherein said vibration source is vibrationally coupled to said wafer carrier via said spindle.

4. The system of claim 2, wherein said vibration source rotates around said axis at a rate different than said wafer carrier.

5. The system of claim 4, wherein the oscillatory force changes with time.

6. The system of claim 4, wherein the drive for rotating said wafer carrier around said axis varies the rotation with time.

7. The system of claim 5, further comprising a controller for selectively changing at least one of said oscillatory force and said rate of rotation of said vibration source.

8. The system of claim 1, wherein said wafer carrier includes a plurality of wafer pockets with a non-planar bottom.

9. The system of claim 8, wherein said wafer pockets include vertical dimples on the edge of each of said pockets.

10. A method for treating wafers, comprising:
rotating a wafer carrier at a first rotational rate around an axis,
applying an oscillatory force substantially transverse to said axis to said wafer carrier so that a plurality of wafers placed in said wafer carrier exhibit planetary motion, and
treating said plurality of wafers.

11. The method of claim 10, further comprising:
rotating the vibratory source of said oscillatory force around said axis at a second rotational rate different from said first rotational rate.

12. The method of claim 10, further comprising:
changing said oscillatory force with time.

13. The method of claim 10, wherein said step of rotating a wafer carrier at a first rotational rate around an axis varies with time.

14. The method of claim 11, wherein said vibration source is selected from the group of a piezoelectric motor and a solenoid.
